(19) United States
(12) Patent Application Publication
(10) Pub. No.: US 2016/0012612 A1
(43) Pub. Date: Jan. 14, 2016

(54) DISPLAY CONTROL METHOD AND SYSTEM

(71) Applicant: FUJITSU LIMITED, Kawasaki-shi (JP)

(72) Inventor: Susumu KOGA, Kawasaki (JP)

(73) Assignee: FUJITSU LIMITED, Kawasaki-shi (JP)

(21) Appl. No.: 14/716,066

(22) Filed: May 19, 2015

(30) Foreign Application Priority Data
Jul. 10, 2014 (JP) 2014-142394

(51) Int. Cl. G06T 11/00; G09G 5/00; G06K 9/00; G09G 5/397

(52) U.S. Cl. CPC G06T 11/00; G09G 5/397; G09G 5/003; G06K 9/00671; G09G 2340/12

(57) ABSTRACT

A display control method includes acquiring a first content and a second content associated with a specific object detected from an image; determining a first display position of the first content based on a position of the specific object in the image; determining a second display position of the second content based on the position of the specific object; determining, based on the first display position and the second display position, whether the first content is displayed behind the second content; controlling the display to display the second content; and controlling the first content to be selected in response to an instruction for the second content when the first content is displayed behind the second content.

### CROSS-REFERENCE TO RELATED APPLICATION

This application is based upon and claims the benefit of priority of the prior Japanese Patent Application No. 2014-142394, filed on Jul. 10, 2014, the entire contents of which are incorporated herein by reference.

### FIELD

The embodiment discussed herein is related to a technique for controlling display.

### BACKGROUND

An augmented reality (AR) technique for superimposing a content such as an image on a part of an image acquired by an imager of a camera and displaying the content is known. In the AR technique, a content (hereinafter referred to as “AR content” in some cases), which is superimposed and displayed in an augmented space based on positional information and identification information (marker ID) of an AR marker (reference object) recognized from the acquired image, is arranged.

One of advantages of superimposing and displaying the AR content that is superimposition data is that the AR content that does not exist in reality is superimposed and displayed at a position defined in advance on the acquired image as if the AR content is associated with a real object (object existing in an real space) depicted in the acquired image. Thus, additional information such as precautions against a real object or an operation method may be provided to a viewer.

When AR contents are superimposed and displayed on the acquired image, the displayed AR contents may overlap each other due to a limit on a region, an imaging angle, or the like, and the overlapping may cause an AR content existing on the back side to be hidden by an AR content existing on the front side or inhibits the AR content existing on the back side from being selected. Thus, control is executed to rearrange the overlapping AR contents so as to avoid the overlapping and display the AR contents. A conventional technique is disclosed in, for example, Japanese Laid-open Patent Publication No. 2012-198668.

### SUMMARY

According to an aspect of the invention, a display control method includes acquiring a plurality of contents including a first content and a second content associated with a specific object when the specific object is detected from an image captured by an imaging device; determining a first display position of the first content based on a position of the specific object in the image; determining a second display position of the second content based on the position of the specific object; determining, based on the first display position and the second display position, whether the first content is displayed behind the second content on a display; controlling the display to display at least the second content; and controlling, by a processor, the first content to be selected in response to an instruction for the second content displayed on the display when it is determined that the first content is displayed behind the second content on the display.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a schematic configuration of an information processing system;

FIG. 2 is a diagram illustrating an example of a functional configuration of a server;

FIG. 3 is a diagram illustrating an example of functional configurations of terminal devices;

FIG. 4 is a diagram illustrating an example of a hardware configuration of the server;

FIG. 5 is a diagram illustrating an example of hardware configurations of the terminal devices;

FIGS. 6A and 6B are diagrams illustrating examples of data included in the server;

FIGS. 7A, 7B, 7C, 7D, 7E, and 7F are diagrams illustrating an example of data included in the terminal devices;

FIG. 8 is a flowchart of an example of an authoring process;

FIG. 9 is a flowchart of a first embodiment of a display control process;

FIG. 10 is a flowchart of an example of a focus transition process;

FIG. 11 is a diagram illustrating an example of screen display according to a first embodiment;

FIG. 12 is a diagram illustrating another example of the screen display according to the first embodiment;

FIG. 13 is a flowchart of a second embodiment of the display control process;

FIGS. 14A and 14B are diagrams describing an example of the display screen according to the second embodiment;

FIG. 15 is a flowchart of a third embodiment of the display control process;

FIG. 16 is a flowchart of an example of an overlapping determination process; and

FIG. 17 is a diagram illustrating an example of the display screen according to the third embodiment.

### DESCRIPTION OF EMBODIMENTS

As described above, when the position of a displayed AR content (superimposition data) is changed due to rearrangement, a viewer may not appropriately recognize additional information associated with a real object. In addition, even when an AR content is added and arranged so as not to overlap another AR content, the added AR content is located at a relative position to the position of an AR marker used as a reference. Thus, if a position and angle at which the AR marker is recognized are different, the AR content may overlap the other AR content.

According to an aspect, an object of a technique disclosed in an embodiment is to appropriately display superimposition data in a state in which a positional relationship between a real object and the superimposition data is maintained.

Hereinafter, the embodiment is described with reference to the accompanying drawings.

Example of Schematic Configuration of Information Processing System

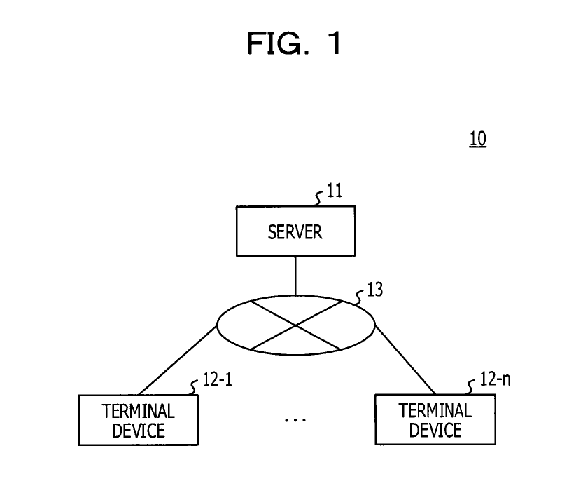

FIG. 1 is a diagram illustrating an example of a schematic configuration of an information processing system. An information processing system 10 illustrated in FIG. 1 includes a server 11 and one or multiple terminal devices 12-1 to 12-n (hereinafter collectively referred to as “terminal devices 12” in some cases). The server 11 and the terminal devices 12 are connected to each other and able to transmit and receive data to and from each other through a communication network 13, for example.

The server 11 manages AR markers as an example of reference objects, one or multiple AR contents associated with identification information (for example, marker IDs) of the AR markers and registered, and the like. The AR markers are markers for specifying details of information of the AR contents, positions at which the AR contents are displayed, and the like, for example. The AR markers are, for example, two-dimensional codes or the like such as images, objects, or the like in which predetermined designs, character patterns, or the like are formed in predetermined regions. The AR markers, however, are not limited to this. The reference objects are not limited to the AR markers and may be real objects that are each a wall clock, a painting, wallpaper, a stationary object, a pipe, a chair, a desk, or the like, for example. In this case, the reference objects are recognized by comparing characteristic information such as the shapes, colors (for example, luminance information or the like), designs, and the like of the real objects with set characteristic information of each reference object and identifying the real objects, and identification information (IDs) associated with the real objects may be used as the aforementioned marker IDs.

The AR contents are model data of objects arranged in a three-dimensional virtual space corresponding to a real space or the like, and are superimposition data (object information) superimposed and displayed on an image acquired by a terminal device 12, for example. The AR contents are displayed at positions set based on relative coordinates (in a marker coordinate system) using the AR markers included in the acquired image as references, for example. The marker coordinate system is, for example, a three-dimensional spatial coordinate system (X, Y, Z), but is not limited to this. The marker coordinate system may be a two-dimensional plane coordinate system (X, Y).

The AR contents according to the embodiment are associated with the marker IDs and the like and are each in the form of a text, an icon, animation, a mark, a pattern, an image, a video image, or the like, for example. In addition, the AR contents are not limited to contents to be displayed and output and may be information such as sounds.

The server 11 registers information (for example, the marker IDs, positional information of the AR contents, and the like), by a process (authoring process) of setting the AR contents in the terminal device 12, on the AR markers acquired from a terminal device 12 and the AR contents set at relative positions to the positions of the AR markers used as the references, for example. In addition, when acquiring setting information of one or multiple AR contents associated with a marker ID from a terminal device 12, the server 11 registers and manages information (for example, AR content IDs, coordinate values, rotational angles, information of enlargement and reduction, information of regions for storing the AR contents, and the like) of the AR contents. When receiving a request to acquire an AR content or the like from a terminal device 12, the server 11 extracts information on the AR content associated with a marker ID transmitted from the terminal device 12 and registered and transmits the extracted information to the terminal device 12.

The server 11 may be a personal computer (PC) or the like, but is not limited to this. For example, the server 11 may be a cloud server having at least one processing device and configured through cloud computing.

The terminal device 12 executes the process (hereinafter referred to as “authoring process” in some cases) of associating an AR content with an AR marker included in an acquired image and setting the AR content to be superimposed and displayed on the acquired image. In addition, the terminal device 12 executes a process of recognizing the AR marker included in the acquired image, superimposing and displaying, on the acquired image, the AR content associated with the recognized AR marker and set, and outputting the image.

For example, the terminal device 12 uses an imager of a camera included in the terminal device 12 or the like to image an AR marker placed near an object (for example, an object to be managed (or inspected), such as a pipe or a server rack) in the real space and acquires an image of the AR marker in the authoring process. In addition, the terminal device 12 may acquire, through the communication network 13 or the like, an image including the AR marker imaged by an external device.

In addition, the terminal device 12 recognizes the AR marker from the acquired image, a video image, or the like (hereinafter referred to as “acquired image”). The terminal device 12 associates an AR content with a marker ID obtained by the marker recognition and arranges the AR content at a relative position to the position of the imaged AR marker used as a reference on the acquired image displayed on a display unit included in the terminal device 12. Upon the arrangement of the AR content, an arrangement angle (rotational angle), a rate of enlarging or reducing the AR content with respect to a basic size, and the like may be set. The terminal device 12 registers, in the server 11, information of the AR content associated with the marker ID and set, positional information (coordinate position) of the arranged AR content, the rotational angle of the AR content, the rate of enlarging or reducing the AR content, and the like.

In order to display the AR content associated with the AR marker and registered, the terminal device 12 acquires the marker ID associated with the AR marker within the acquired image by the marker recognition and uses the acquired marker ID to provide a request to acquire the AR content to the server 11 or the like. The terminal device 12 acquires information (for example, the AR content ID, coordinate values, a rotational angle, information of enlargement or reduction, information of a region for storing the AR content, and the like) of the AR content associated with the marker ID from the server 11 and uses the acquired information to superimpose and display the AR content on the acquired image.

The terminal device 12 displays, based on the position of specific image data displayed on the display unit, superimposition data at a position determined for the specific image data. When the superimposition data exists behind other superimposition data and the selection of the other superimposition data is instructed, the terminal device 12 causes the superimposition data to be in a selected state.

In display control of the AR content by the information processing system 10 illustrated in FIG. 1, the AR content is arranged in a set space within a space included in the acquired image. In the embodiment, based on a positional relationship between the AR marker and the camera (imager), a region to be projected in an arrangement space for the imager is adjusted and superimposition data is arranged in the adjusted projected region.

If specific image data such as an AR marker is included in an image to be displayed on a screen of the display unit, the terminal device 12 superimposes and displays superimposition data associated with the specific image data. In this case, the terminal device 12 displays, based on the position of the specific image data displayed on the display unit, the superimposition data at a position determined for the specific image data. If the superimposition data exists behind other superimposition data, the terminal device 12 controls the rate of transparency of the other superimposition data and displays the other superimposition data. The control of the rate of transparency is executed to increase the rate of transparency as to cause an image of the data to be transparent or semi-transparent, but is not limited to this.

In the information processing system 10, the server 11 may receive, from the terminal device 12, a marker ID, positional information of the terminal device 12, an image including an AR marker, and the like and execute the display control on an AR content associated with the marker ID on the side of the server 11, for example.

In this case, the server 11 generates an image in which the AR content is superimposed and displayed on the image including the AR marker, and the server 11 transmits the generated image to the terminal device 12. The terminal device 12 transmits, to the server 11, information such as the marker ID of the AR marker recognized by the marker recognition, information of a position at which the image is acquired, the acquired image, and the like. Then, the terminal device 12 acquires the superimposed image of the AR content processed by the server 11 and displays the image on the screen.

Each of the terminal devices 12 is, for example, a tablet terminal, a smartphone, a personal digital assistant (PDA), a laptop computer, or the like, but is not limited to this. For example, each of the terminal devices 12 may be a game machine, a communication terminal such as a mobile phone, or the like.

The communication network 13 is, for example, the Internet, a local area network (LAN), or the like, but is not limited to this. The communication network 13 may be a wired network or a wireless network or a combination of the wired network and the wireless network.

The information processing system 10 illustrated in FIG. 1 includes the single server 11 and the number n of the terminal devices 12, but is not limited to this. The information processing system 10 may include a plurality of servers.

Example of Functional Configuration of Server 11

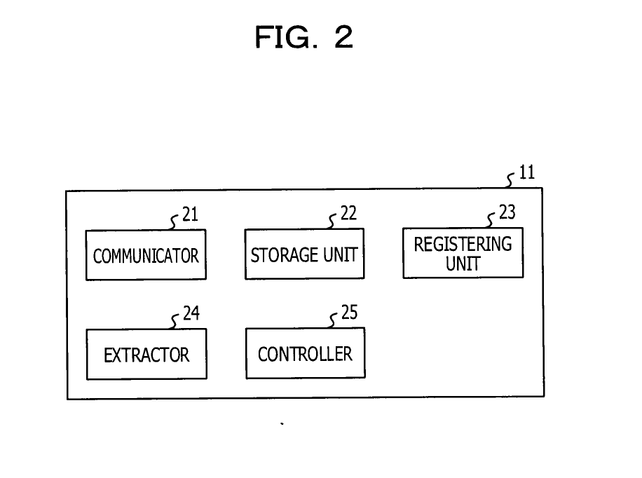

Next, an example of a functional configuration of the aforementioned server 11 is described with reference to FIG. 2. FIG. 2 is a diagram illustrating the example of the functional configuration of the server. The server 11 includes a communicator 21, a storage unit 22, a registering unit 23, an extractor 24, and a controller 25.

The communicator 21 transmits and receives data to and from the terminal devices 12, another device, and the like through the communication network 13. The communicator 21 receives, from each of the terminal devices 12, a request to register an AR content or the like, information (coordinate values, a rotational angle, an enlargement or reduction rate, and other content information) of an AR content associated with an AR marker and registered, and the like, for example. The communicator 21 receives identification information (for example, a marker ID) of a registered AR marker, acquires information of an AR content associated with the AR marker from the storage unit 22 or the like, and transmits the received information and the acquired information to the terminal devices 12.

The storage unit 22 stores various types of information to be used for information processing such as a display control process according to the embodiment. The storage unit 22 stores a marker ID management table, an AR content management table, a terminal screen management table, a terminal operation management table, an overlapping region determination management table, a region management table, and the like, for example. The aforementioned information may be managed based on identification information (user IDs) of users, identification information (group IDs) of groups to which the users belong, and the like. Thus, different AR contents may be managed for the same marker ID that varies per user or group. Information stored in the storage unit 22 is not limited to the aforementioned information.

The registering unit 23 registers various types of registration information such as AR contents acquired from the terminal devices 12 and the like. For example, the registering unit 23 associates information (marker IDs) identifying AR markers with information of AR contents and registers the information identifying the AR markers and the information of the AR contents. The registered information is stored in the storage unit 22. The stored information may be associated with the user IDs and group IDs acquired from the terminal devices 12 and may be managed. The registering unit 23 may change, update, and delete the registered AR content information in accordance with instructions from the terminal devices 12.

When receiving a request to acquire an AR content from a terminal device 12, the extractor 24 references the storage unit 22 based on identification information (or a marker ID) and extracts information of the AR content. The communicator 21 transmits a determination requirement extracted by the extractor 24, the AR content extracted by the extractor 24, and the like to the terminal device 12 that has transmitted the marker ID.

When receiving the marker ID, positional information, an acquired image, and the like from the terminal device 12, the extractor 24 may extracts the AR content associated with the marker ID, superimpose the extracted AR content on the acquired image, and transmit the superimposed image to the terminal device 12.

The controller 25 controls an overall configuration of the server 11. The controller 25 executes processes so as to cause the communicator 21 to transmit and receive information of various types, cause the storage unit 22 to store data, cause the registering unit 23 to register AR content information and the like, and cause the extractor 24 to extract AR content information and the like, for example. Details of the control executed by the controller 25 are not limited to this. For example, the controller 25 may execute an error process and the like.

Example of Functional Configurations of Terminal Devices 12

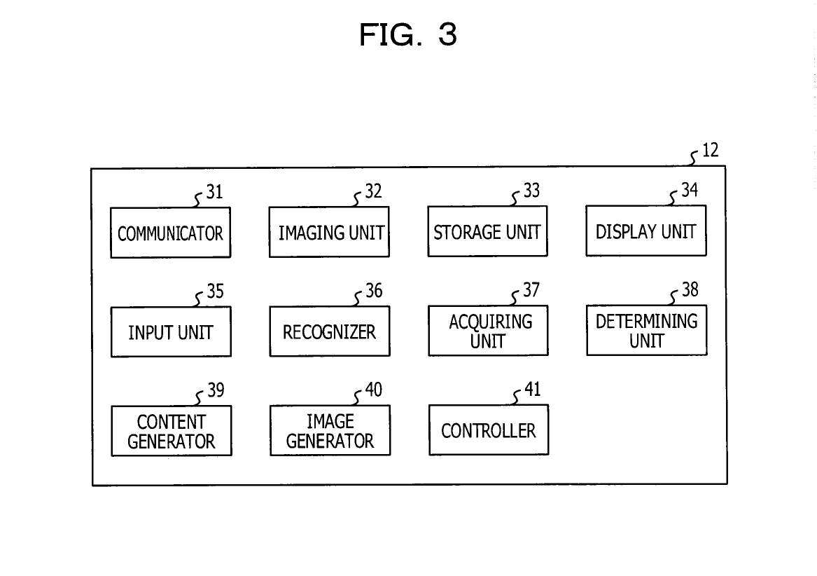

Next, an example of functional configurations of the aforementioned terminal devices 12 is described with reference to FIG. 3. FIG. 3 is a diagram illustrating the example of the functional configurations of the terminal devices. The terminal devices 12 each include a communicator 31, an imager 32, a storage unit 33, a display unit 34, an input unit 35, a recognizer 36, an acquirer 37, a determining unit 38, a content generator 39, an image generator 40, and a controller 41.

The communicator 31 transmits and receives data to and from the server 11, another device, and the like through the communication network 13. The communicator 31 transmits, to the server 11 or the like, various types of setting information (AR content information) of an AR content that is associated with an AR marker included in an acquired image and is superimposed and displayed at a predetermined position on the acquired image and the like in the authoring process, for example. The acquired image may be an image acquired by the imager 32 or an image acquired from an external through the communication network 13.

In order to acquire a registered AR content associated with an AR marker included in an image acquired by the terminal device 12, the communicator 31 transmits, to the server 11, identification information (a marker ID) of the AR marker recognized by the marker recognition executed by the recognizer 36 and receives information of the AR content associated with the transmitted marker ID or the like.

The imager 32 acquires a still image or acquires an image (video image) at frame intervals set in advance. The imager 32 outputs the acquired image to the controller 41 and causes the acquired image to be stored in the storage unit 33.

The storage unit 33 stores various types of information to be used for the display control according to the embodiment. The storage unit 33 includes a marker ID management table, an AR content management table, a terminal screen management table, a terminal operation management table, an overlapping region determination management table, a region management table, and the like, for example. Information stored in the storage unit 22 is not limited to the aforementioned information. The information stored in the storage unit 22 includes information set by the terminal device 12 and information acquired from the server 11. Information upon the setting may be deleted after being transmitted to the server 11.

The display unit 34 displays the image acquired by the imager 32, an image received from an external through the communication network 13, and the like. If an AR marker is included in image data (the acquired image and the received image) to be displayed, the display unit 34 superimposes (draws) and displays an AR content (superimposition data) associated with the AR marker at a predetermined position.

For example, the display unit 34 displays set character information such as “precautions”, “danger”, and “check” and templates such as AR contents including arrows, signs, and marks in the authoring process. In addition, the display unit 34 displays a superimposed image generated by the image generator 40, an AR content generated by the content generator 39, and the like. The display unit 34 is a display, a monitor, or the like, but is not limited to this.

The input unit 35 receives details of an operation from a user or the like. For example, if the display unit 34 is a touch panel or the like, the input unit 35 acquires coordinates of a position touched on the touch panel. In addition, the input unit 35 receives user operations such as a single tap operation, a double tap operation, a long tap operation, a swiping operation, a flick operation, a pinch-in operation, and a pinch-out operation by a multi-touch interface of the touch panel.

If the terminal device 12 has a keyboard, operational buttons, and the like, the input unit 35 receives information corresponding to a key selected by the user and an operational button selected by the user.

The recognizer 36 recognizes a reference object (for example, an AR marker) or the like included in an input image (acquired image or received image). For example, the recognizer 36 executes image recognition on the image acquired by the imager 32, executes matching with at least one AR marker image set in advance, and determines whether or not an AR marker exists. If the AR marker exists, the recognizer 36 acquires identification information associated with the AR marker set in advance. A method for recognizing the AR marker is not limited to this. For example, an existing marker recognition engine, an existing marker reader, or the like may be used to read the identification information directly from the shape, design, or the like of the AR marker. In addition, the recognizer 36 acquires a relative position (coordinates) of the AR marker to the imager 32 and acquires identification information (marker ID) of the AR marker. In the embodiment, the same identification information may be acquired from different reference objects (AR markers).

In the embodiment, by providing an AR marker to a real object (target object) included in an acquired image (image data to be displayed on the display unit 34), a method for using the object, a task procedure, precautions, or the like may be superimposed and displayed at a predetermined position on the acquired image as an AR content associated with identification information of the AR marker.

The reference objects according to the embodiment are not limited to the AR markers and may be real objects included in an acquired image. In this case, the recognizer 36 extracts characteristic information of the real objects (that are each a wall clock, a painting, a pipe, or the like, for example) from the acquired image, compares the extracted characteristic information with characteristic information registered in advance, identifies the objects from characteristic information that is the same as the extracted characteristic information or of which similarities are equal to or larger than a predetermined value. Then, the recognizer 36 acquires identification information of the identified objects. The characteristic information may be acquired based on characteristic amounts such as information of edges, luminance, and the like of the objects. The objects may be identified based on how much the characteristic information matches. The characteristic information, however, is not limited to this.

The recognizer 36 may cause templates defining the AR markers or the shapes of the objects to be stored in the storage unit 33, and the recognizer 36 may execute matching with the templates and recognize the AR markers or the objects.

The acquirer 37 transmits, to the server 11, a marker ID associated with an AR marker (reference object) read by the recognizer 36 and acquires information on whether or not AR content information associated with the marker ID exists. If the AR content information associated with the marker ID exists, the acquirer 37 acquires the AR content information.

The acquirer 37 may execute a process of acquiring the information immediately after the recognition process executed by the recognizer 36 or may execute the process of acquiring the information at another time.

The determining unit 38 determines whether or not multiple AR contents superimposed and displayed on an acquired image by the image generator 40 overlap each other. Whether or not the AR contents overlap each other may be determined based on a determination requirement set in advance. For example, whether or not the AR contents overlap each other may be determined based on how much the AR contents overlap each other (overlapping rate) or the like as the determination requirement. The determination requirement, however, is not limited to this. If the AR contents overlap each other, the determining unit 38 may acquire the order of the overlapping AR contents, the number of the overlapping AR contents, and the like.

In addition, the determining unit 38 determines that the user taps coordinates at which the AR contents overlap each other by a user operation or the like. Then, the determining unit 38 outputs, to the controller 41, information representing that the user taps the coordinates. Whether or not the AR contents overlap each other may be determined using coordinate values included in content information or the like, but is not limited to this.

The content generator 39 associates positional information of an AR content, display data forming the AR content, and a marker ID with each other and generates AR content information. The AR content information is the AR content, coordinate values, a rotational angle, an enlargement or reduction rate, and the like, but is not limited to this. For example, the content generator 39 may convert a point specified by the user on the screen into a coordinate system (marker coordinate system) using the position of an AR marker as a reference and treat coordinate values after the conversion as relative positional information based on the AR marker, but is not limited to this.

The image generator 40 generates an AR content to be associated with an AR marker and displayed. The image generator 40 generates a superimposed (synthesized) image based on setting information and template information used for the generation of the AR content, for example. In addition, the image generator 40 generates various images other than the superimposed image. The image generator 40 superimposes and displays the AR content on an image while using a relative position to the AR marker as a reference. The image generator 40 displays, on the screen, an AR content subjected to projective transformation based on an angle of an AR marker included in an acquired image with respect to the imager 32.

If multiple AR contents associated with a marker ID are displayed while overlapping each other, the image generator 40 displays the AR contents while setting the rate of transparency of the AR contents to predetermined values and making the AR contents semi-transparent or transparent based on the result of the determination made by the determining unit 38 and based on the order of the overlapping AR contents or the like. In addition, the image generator 40 may display the number of the overlapping AR contents on the screen.

The controller 41 controls all processes of the constituent parts included in the terminal device 12. The controller 41 executes processes so as to cause the imager 32 to acquire an image, cause the display unit 34 to display information of various types on the screen, cause the input unit 35 to execute various settings related to the display control, and the like. In addition, the controller 41 executes processes so as to cause the recognizer 36 to recognize an AR marker included in an acquired image, cause the acquirer 37 to acquire an AR content, cause the determining unit 38 to determine overlapping, cause the content generator 39 to generate an AR content, cause the image generator 40 to generate a superimposed image, and the like. Details of the control by the controller 41 are not limited to this. For example, the controller 41 may execute an error process and the like. The controller 41 may activate an AR application for executing the display control process according to the embodiment and terminate the AR application.

Example of Hardware Configuration of Server 11

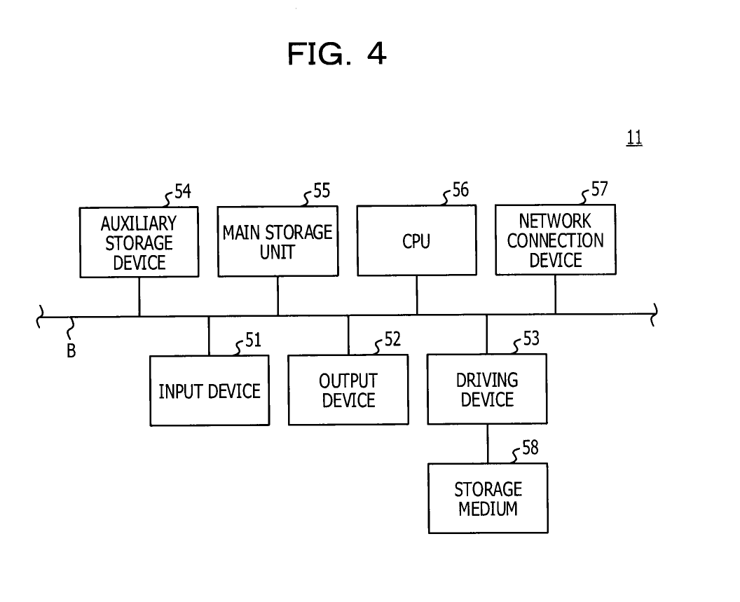

Next, an example of a hardware configuration of the server 11 is described with reference to FIG. 4. FIG. 4 is a diagram illustrating the example of the hardware configuration of the server. In the example illustrated in FIG. 4, the server 11 includes an input device 51, an output device 52, a driving device 53, an auxiliary storage device 54, a main storage device 55, a central processing unit (CPU) 56, and a network connection device 57 that are connected to each other by a system bus B.

The input device 51 includes pointing devices such as a keyboard and a mouse and an audio input device such as a microphone. The pointing devices are operated by a user or the like. The input 51 receives input such as an instruction to execute a program from the user or the like, operational information of various types, information to be used to activate software or the like, and the like.

The output device 52 includes a display for displaying various windows and data that are used to operate a computer body (server 11) in order to execute the process according to the embodiment and the like. The output device 52 may display the progress, result, and the like of the execution of a program by a control program included in the CPU 56.

In the embodiment, an execution program installed in the computer body is provided from a storage medium 58 or the like. The storage medium 58 may be set in the driving device 53. The execution program stored in the storage medium 58 is installed in the auxiliary storage device 54 through the driving device 53 from the storage medium 58 based on a control signal from the CPU 56.

The auxiliary storage device 54 is a storage unit such as a hard disk drive (HDD) or a solid state drive (SSD), for example. The auxiliary storage device 54 is configured to store the execution program (information processing (display control) program) according to the embodiment, the control program included in the computer, and the like and receive and output the programs. The auxiliary storage device 54 may read information from stored information and write information based on control signals from the CPU 56 or the like.

The main storage device 55 is configured to store the execution program read by the CPU 56 from the auxiliary storage device 54 and the like. The main storage device 55 is a read only memory (ROM), a random access memory (RAM), or the like.

The CPU 56 controls processes of the overall computer and achieves the processes or executes calculation of various types and controls input and output of data to and from the hardware constituent parts, based on the control program such as an operating system (OS) and the execution program stored in the main storage device 55. Information and the like that are used during the execution of the programs may be acquired from the auxiliary storage device 54, and the results of the execution and the like may be stored in the auxiliary storage device 54.

Specifically, the CPU 56 executes a program installed in the auxiliary storage device 54 based on an instruction to execute the program from the input device 51 or the like and thereby executes a process corresponding to the program on the main storage device 55, for example. For example, the CPU 56 executes the information processing program and thereby executes processes so as to cause the aforementioned registering unit 23 to register AR content information and the like, cause the extractor 24 to extract AR content information and the like, cause the controller 25 to execute the display control, and the like. Details of the processes by the CPU 56 are not limited to this. The details of the processes executed by the CPU 56 are stored in the auxiliary storage device 54 or the like.

The network connection device 57 communicates with the terminal devices 12 and another external device through the aforementioned communication network 13. The network connection device 57 is connected to the communication network 13 or the like and acquires the execution program, software, setting information, and the like from the external device or the like based on a control signal from the CPU 56. In addition, the network connection device 57 may provide the results of the execution of the program to the terminal devices 12 and the like and provide the execution program according to the embodiment to the external device and the like.

The storage medium 58 is a computer-readable storage medium storing the execution program and the like, as described above. The storage medium 58 is, for example, a portable storage medium such as a semiconductor memory such as a flash memory, a CD-ROM, or a DVD, but is not limited to this.

The information processing such as the display control process according to the embodiment may be achieved by installing the execution program (for example, the information processing program or the like) in the hardware configuration illustrated in FIG. 4 and causing the hardware resources and the software to collaborate with each other.

Example of Hardware Configurations of Terminal Devices 12

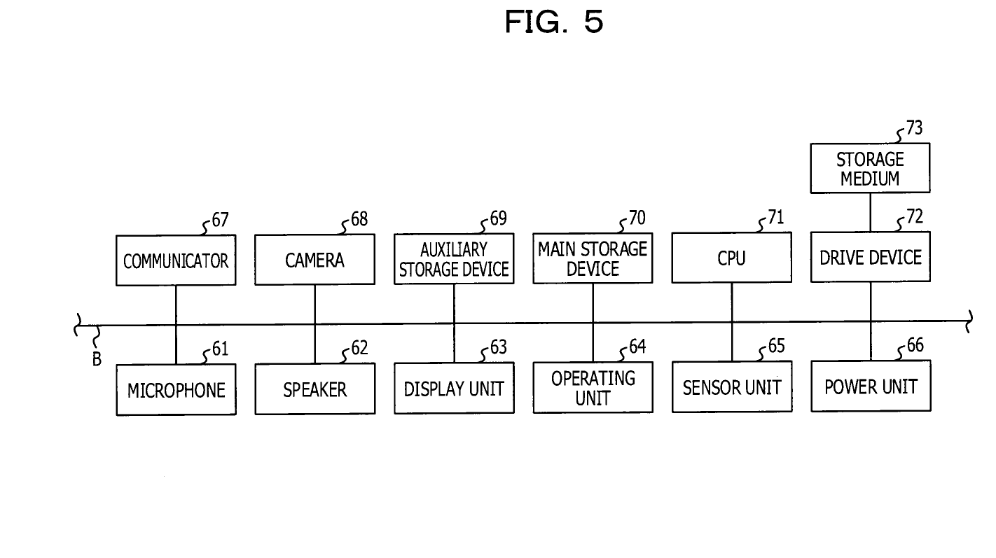

Next, an example of hardware configurations of the terminal devices 12 is described with reference to FIG. 5. FIG. 5 is a diagram illustrating the example of the hardware configurations of the terminal devices. In the example illustrated in FIG. 5, a terminal device 12 includes a microphone 61, a speaker 62, a display unit 63, an operating unit 64, a sensor unit 65, a power unit 66, a communicator 67, a camera 68, an auxiliary storage device 69, a main storage device 70, a CPU 71, and a driving device 72 that are connected to each other by a system bus B.

The microphone 61 receives voice of the user and another sound. The speaker 62 outputs audio data, a ringtone, and the like and outputs voice of a call party. The microphone 61 and the speaker 62 may be used for communication between the user and another person through a communication function or the like, but are not limited to this. The microphone 61 and the speaker 62 may be used to receive and output audio information.

The display unit 63 displays a screen set by the OS and various applications to the user. In addition, the display unit 63 may be a touch panel display or the like. In this case, the display unit 63 has a function as an input and output unit. The display unit 63 is, for example, a liquid crystal display (LCD), an organic electroluminescence (EL) display, or the like.

The operating unit 64 is an operation button displayed on the screen of the display unit 63, an operation button arranged outside the terminal device 12, or the like. The operation button may be a power supply button or a sound volume control button, for example. The operation button may be operation keys arranged in a predetermined order and provided for character input.

The user performs a certain operation on the screen of the display unit 63. When the user presses the aforementioned operation button, a position touched by the user is detected by the display unit 63. In addition, the display unit 63 may display the results of the execution of an acquired image application, a content, an icon, a cursor, and the like on the screen.

The sensor unit 65 detects an operation of the terminal device 12 at a certain time or detects a continuous operation of the terminal device 12. For example, the sensor unit 65 detects an inclination angle, acceleration, orientation, position, and the like of the terminal device 12, but is not limited to this. The sensor unit 65 is, for example, an inclination sensor, an acceleration sensor, a gyro sensor, a global positioning system (GPS), or the like, but is not limited to this.

The power unit 66 supplies power to the parts of the terminal device 12. The power unit 66 is, for example, an internal power supply such as a battery, but is not limited to this. The power unit 66 may detect the amount of power at predetermined time intervals and monitor a remaining amount of power and the like.

The communicator 67 is a communication data transmitting and receiving unit that uses an antenna or the like to receive a wireless signal (communication data) from a base station and transmits a wireless signal to the base station through the antenna. The communicator 67 may transmit and receive data to and from the server 11 through the communication network 13, the base station, and the like.

In addition, the communicator 67 may use a communication method such as infrared communication, Wi-Fi (registered trademark), or Bluetooth (registered trademark) to execute near field communication with computers such as the other terminal devices 12.

The camera 68 is an imager included in the terminal device 12. Alternatively, the camera 68 may be an external device attachable to the terminal device 12. The camera 68 acquires image data corresponding to a set angle of view. The angle of view is set based on camera parameters such as dimensions (resolution) of an imaging area, a focal distance of a lens, magnification, and a distortion level of the lens, for example. The camera 68 may acquire a still image or a video image continuously acquired at a predetermined frame rate.

The auxiliary storage device 69 is a storage unit such as an HDD or an SSD, for example. The auxiliary storage device 69 is configured to store various programs and receive and output data.

The main storage device 70 is configured to store the execution program read from the auxiliary storage device 69 in accordance with an instruction from the CPU 56 and the like and store various types of information obtained during the execution of the program. The main storage device 70 is, for example, a ROM, a RAM, or the like, but is not limited to this.

The CPU 71 controls, based on a control program such as the OS and the execution program stored in the main storage device 70, the processes of the overall computer, such as calculation of various types and input and output of data from and to the hardware constituent parts, and achieves processes to be executed in the display control.

Specifically, the CPU 71 executes a program installed in the auxiliary storage device 69 based on an instruction, provided by the operating unit 64 or the like, to execute the program or the like and thereby executes a process corresponding to the program on the main storage device 70, for example. For example, the CPU 71 executes the information processing program and thereby executes processes so as to cause the aforementioned input unit 35 to set an AR content associated with an AR marker (marker ID) and the like, cause the recognizer 36 to recognize a reference object such as an AR marker, and the like. In addition, the CPU 71 causes the acquirer 37 to acquire characteristic information, causes the determining unit 38 to determine overlapping of AR contents, causes the content generator 39 to generate an AR content, causes the image generator 40 to generate a superimposed image, and the like. Details of the processes by the CPU 71 are not limited to the aforementioned details. The details of the processes executed by the CPU 71 may be stored in the auxiliary storage device 69.

The storage medium 73 and the like may be attached and detached to and from the driving device 72. The driving device 72 may read various types of information stored in the storage medium 73 and write certain information in the storage medium 73. The driving device 72 is, for example, a medium loading slot or the like, but is not limited to this.

The storage medium 73 is a computer-readable storage medium configured to store the execution program and the like, as described above. The storage medium 73 may be a semiconductor memory such as a flash memory, for example. Alternatively, the storage medium 73 may be a portable storage medium such as a USB memory, but is not limited to this.

In the embodiment, since the execution program (for example, the information processing program or the like) is installed in the hardware configuration of the aforementioned computer body, the hardware resources and the software collaborate with each other so as to achieve the information processing such as the display control process according to the embodiment.

In addition, the information processing program that corresponds to the aforementioned display control process may reside as the AR application on the terminal device and may be activated in accordance with an activation instruction.

Example of Data

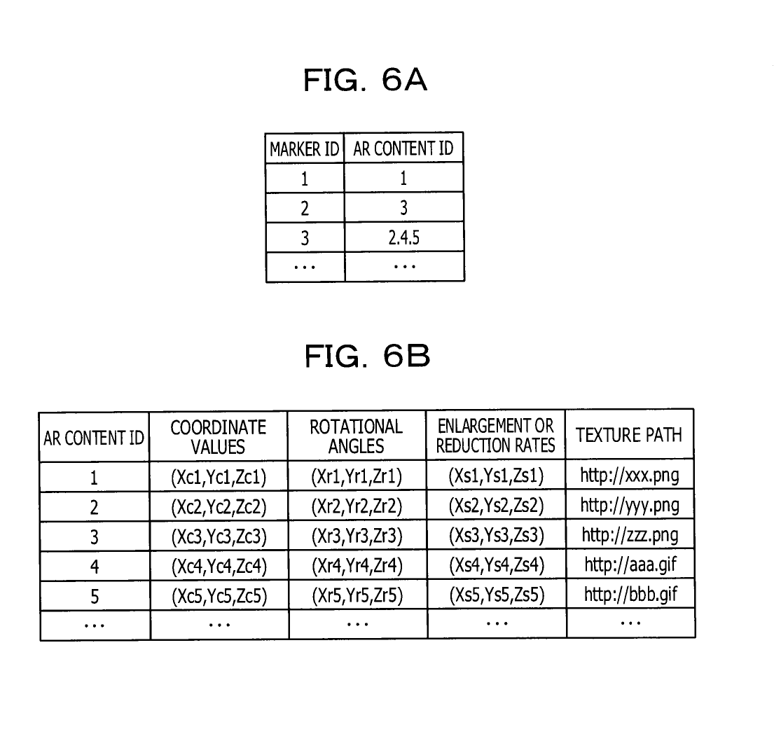

Next, examples of various types of data that is applicable to the embodiment are described with reference to FIGS. 6A and 6B. FIGS. 6A and 6B are diagrams illustrating the examples of the data included in the server. FIG. 6A illustrates an example of the marker management table. FIG. 6B illustrates an example of the AR content management table.

The marker management table illustrated in FIG. 6A includes items for “marker IDs” and “AR content IDs”, for example, but is not limited to this. In the marker management table, the AR content IDs are associated with the marker IDs and set. One or multiple AR content IDs may be associated with each marker ID. For example, AR content IDs “2”, “4”, and “5” are associated with a marker ID “3”.

The AR content management table illustrated in FIG. 6B includes items for “AR content IDs”, “coordinate values”, “rotational angles”, “enlargement or reduction rates”, “texture paths”, and the like, but is not limited to this. The coordinate values are positional information (coordinate values) of AR contents in the marker coordinate system (relative coordinate system with the center of an AR marker as its origin), but is not limited to this.

The rotational angles are inclination angles of the AR contents with respect to a set basic angle in three directions (x, y, z). The enlargement or reduction rates are rates at which the AR contents are enlarged or reduced in the three directions using a set size as a reference. The rotational angles and the enlargement or reduction rates may be set by the user in the authoring process or may be set to values corresponding to the size (distance to an AR marker) and angle of the AR marker in an acquired image.

The texture paths are information of destinations (paths) for storing image files (image data), video data, or the like that are displayed in the AR contents. Thus, for example, the data may be stored in a device other than the server 11, and the AR contents may be acquired from the storage destinations. Each texture path is provided for one or multiple AR contents. A data format of the AR contents may be PNG or JPG, but is not limited to this. The data format may be GIF, TIFF, AVI, WAV, MPEG, or the like, for example. In addition, the AR contents are not limited to images and video images and may be audio data. In this case, the interested audio data is stored in the texture paths.

The marker management table illustrated in FIG. 6A and the AR content management table illustrated in FIG. 6B are information acquired from the terminal devices 12 in the authoring process by the user (administrator or the like) and are registered in the terminal devices 12. In the server 11, the aforementioned information may be associated with user IDs and group IDs and stored in the storage unit 22. Thus, even if the same marker ID is recognized, a detail of an AR content to be superimposed and displayed may be associated with a user ID, a group ID, and the like and changed.

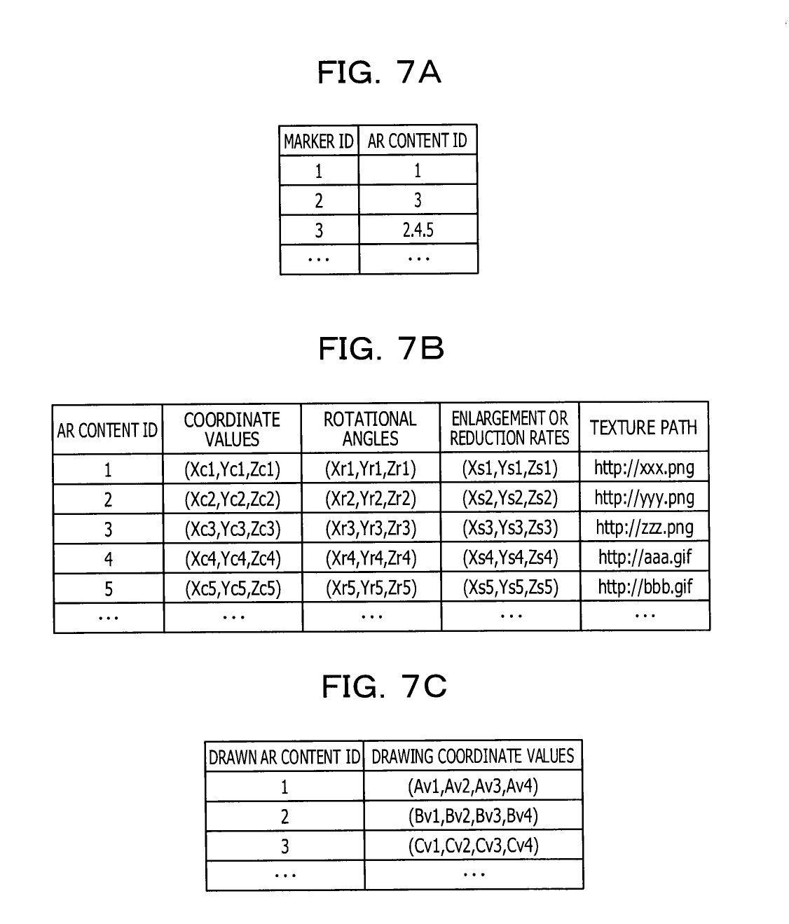

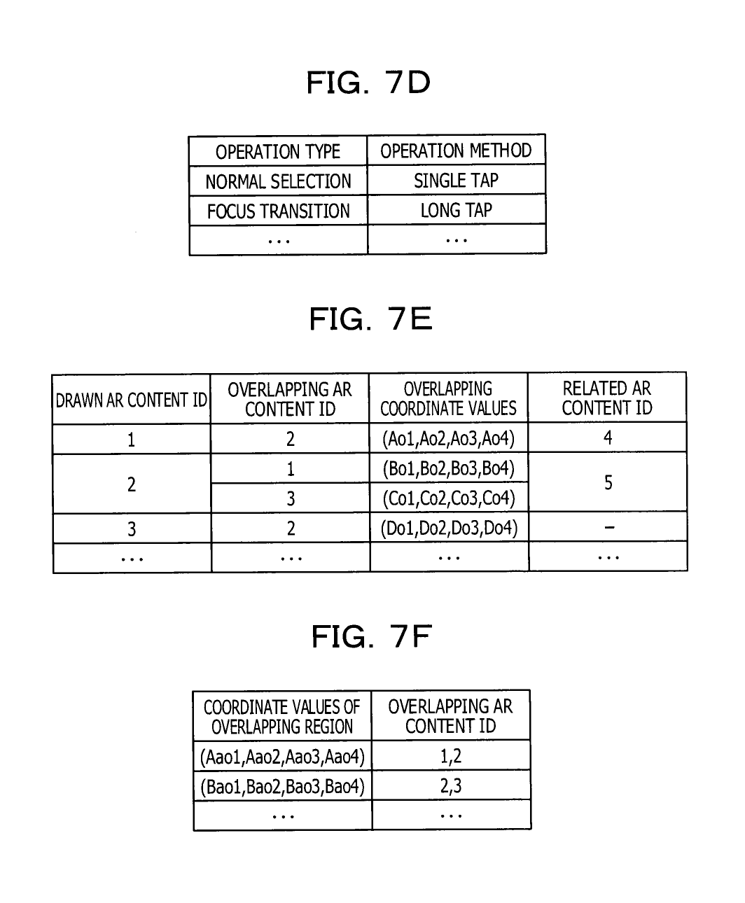

FIGS. 7A, 7B, 7C, 7D, 7E, and 7F are diagrams illustrating examples of data included in each terminal device 12. FIG. 7A illustrates the marker management table. FIG. 7B illustrates the AR content management table. FIG. 7C illustrates the screen management table. FIG. 7D illustrates the operation management table. FIG. 7E illustrates the overlapping region determination management table. FIG. 7F illustrates the region management table.

The tables illustrated in FIGS. 7A and 7B have the same configurations as the aforementioned tables illustrated in FIGS. 6A and 6B, and a description thereof is omitted. The screen management table illustrated in FIG. 7C includes items for “drawn AR content IDs”, “drawing coordinate values”, and the like, but is not limited to this. The drawn AR content IDs are identification information of AR contents that are associated with marker IDs of AR markers included in an acquired image and are superimposed and displayed on the acquired image. The drawing coordinate values are coordinate values of four corners of each of the AR contents and are acquired when the AR contents are drawn on the screen of the display unit 34 of the terminal device 12.

Coordinate values of four corners of each of the AR contents are coordinate values of the corners if the AR contents or regions surrounding the AR contents are rectangles. Information of the drawing coordinate values, however, is not limited to this. For example, if the AR contents are circles, information of coordinates of the centers of the circles and radii of the circles or the like is stored as the information of the drawing coordinate values.

The drawing coordinate values are generated by the image generator 40 and updated in response to a change in a position at which an AR marker is recognized or a change in an imaging angle. For example, the drawn coordinate values are updated based on the display of an AR content subjected to projective transformation based on an imaging angle of an AR marker in an acquired image, a rate of enlarging or reducing the acquired image based on the size of the AR marker, and the like. Thus, the screen management table illustrated in FIG. 7C is updated based on a currently acquired image at predetermined times, or at predetermined time intervals, or at times each corresponding to the number of frames, or when the amount of a movement of the terminal device 12 is equal to or larger than a predetermined value. The timing of updating the screen management table, however, is not limited to this.

The image generator 40 converts an AR content to be drawn into coordinate values (in a screen coordinate system) on the screen by projective transformation or the like based on the position and angle of an AR marker included in an acquired image. In addition, the image generator 40 may set the converted coordinate values as drawing coordinate values, but is not limited to this. The image generator 40 may use the marker coordinate system.

The operation management table illustrated in FIG. 7D includes items for “operation types”, “operation methods”, and the like, for example, but is not limited to this. For example, the operation types are information identifying set details of the display control according to the embodiment. In addition, the operation methods are information identifying user operations performed using the input unit 35 in order to execute operations of the operation types. The operation methods may be changed based on functions of each terminal device 12, user settings, or the like. For example, as an operation method for executing a focus transition process, the flick operation or the like may be performed, instead of the long tap operation.

The overlapping region determination management table illustrated in FIG. 7E includes items for “drawn content IDs”, “overlapping AR content IDs”, “overlapping coordinate values”, “related AR content IDs”, and the like, for example, but is not limited to this. The overlapping AR content IDs are information identifying AR content IDs of AR contents that are associated with the aforementioned drawn AR content IDs and at least partially overlap the AR contents with the drawn AR content IDs. In addition, as the overlapping coordinate values, coordinate values of four corners of each overlapping region are set. In the example illustrated in FIG. 7E, two AR contents with AR content IDs “1” and “3” overlap an AR content with a drawn AR content ID “2”, coordinate values of four corners of an overlapping region of the AR content with the AR content ID “1” are Bo1, Bo2, Bo3, and Bo4, and coordinate values of four corners of an overlapping region of the AR content with the AR content ID “3” are Co1, Co2, Co3, and Co4. Bo1 to Bo4 and Co1 to Co4 represent two-dimensional or three-dimensional coordinates. The related AR content IDs represent AR content IDs of AR contents that cause simultaneous focus transition.

The AR contents with the related AR content IDs do not overlap another AR content, but have a relationship with the overlapping AR contents. In this case, the display control that is executed on AR contents each overlapping another AR content and having a relationship with the other AR content may be executed on the AR contents with the related AR content IDs. The AR contents with the related AR content IDs are arrow contents pointing the position of a “crack”, a position at which “water leaks”, and the like for text contents representing character information such as the “crack” and “water leaks”. The AR contents with the related AR content IDs, however, are not limited to this. The AR contents with the related AR content IDs may be set by the user upon the authoring process, for example.

Where and how many AR contents overlap each other may be determined from the overlapping region determination management table illustrated in FIG. 7E based on an overlapping AR content ID associated with each of the AR contents and a total value of overlapping regions of the AR contents upon drawing of the AR contents. For example, the determining unit 38 may determine the positions (regions) of overlapping AR contents in the direction from the front side of the screen to the back side of the screen, the order of the overlapping AR contents, and a level of the overlapping (or the number of the overlapping AR contents). The information is used for control to be executed to switch the display of the AR content, for example.

The region management table illustrated in FIG. 7F includes items for “coordinate values of overlapping regions”, “overlapping AR content IDs”, and the like, for example, but is not limited to this. Coordinate values of each of the overlapping regions are coordinate values of four corners of the region in which multiple AR contents overlap each other. Coordinate values of four corners of each of the overlapping regions are coordinate values of the corners if the overlapping regions are rectangles. Information of the coordinate values of the overlapping regions, however, is not limited to this. The overlapping AR content IDs are information identifying AR contents overlapping in the regions. The order of the overlapping AR contents may be determined using the order registered in the region management table illustrated in FIG. 7F or the like. In the example illustrated in FIG. 7F, an AR content with an AR content ID “2” is displayed on an AR content with an AR content ID “1” while overlapping the AR content with the AR content ID “1”, and an AR content with an AR content ID “3” is displayed on the AR content with the AR content ID “2” while overlapping the AR content with the AR content ID “2”. The order is not limited to this. For example, the region management table illustrated in FIG. 7F may include an item for the “order”, and information (for example, overlapping AR content IDs “1, 2, 3” or the like) of the order of the overlapping AR contents from the front side of the screen may be set in the region management table illustrated in FIG. 7F.

Example of Process (Authoring Process) of Setting AR Content by Terminal Device 12

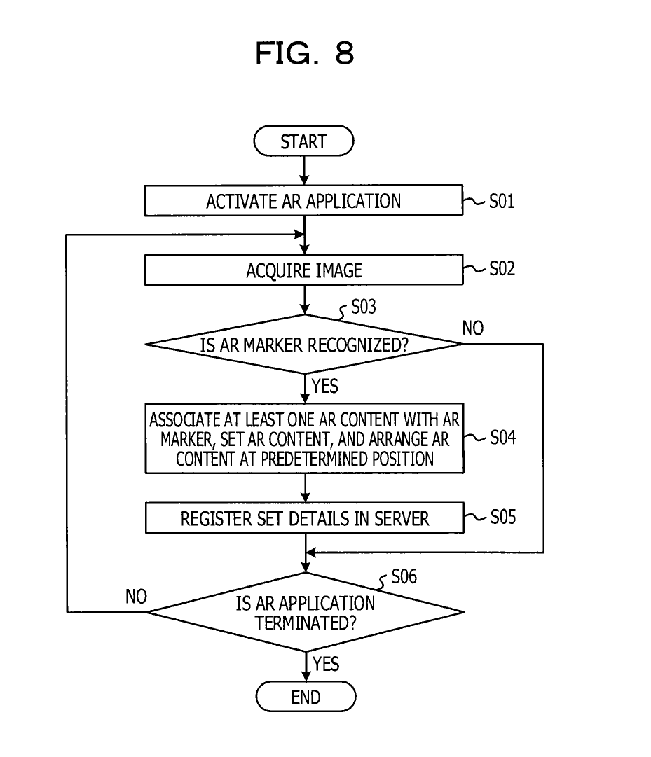

Next, an example of the process (authoring process) of setting an AR content by a terminal device 12 is described using a flowchart. FIG. 8 is the flowchart of the example of the authoring process. In the example illustrated in FIG. 8, the controller 41 activates the AR application in order to execute the authoring process that is an example of the display control (in S01). Then, the imager 32 acquires an image (in S02). The acquired image is an example of image data to be displayed on the display unit 34, but is not limited to this. For example, the imager 32 may acquire, through the communication network 13, an image acquired by an external terminal.

Next, the recognizer 36 executes the marker recognition on the image acquired in the process of S02 and determines whether or not the recognizer 36 recognizes an AR marker included in the image acquired in the process of S02 (in S03). If the AR marker is recognized in the process of S03 (Yes in S03), the content generator 39 associates at least one AR content with the recognized AR marker, sets the AR content, and arranges the AR content at a predetermined position, based on information input from the input unit 35 (in S04).

In the process of S04, the at least one AR content is selected based on a user operation from among templates of multiple AR contents set in advance and is arranged at the predetermined position on the screen. In addition, the content generator 39 sets a rotational angle, an enlargement or reduction rate, and the like for the AR content based on a user operation. The content generator 39 acquires various types of setting information obtained by the user operations or the like.

In the process of S04, if an AR content associated with the recognized AR marker is already set, the AR content may be acquired from the server 11 or the like and displayed on the display unit 34. Thus, a new AR content may be arranged so as not to overlap an existing AR content, and details of the existing AR content may be changed and updated.

The content generator 39 registers details (AR content information) of the set AR content in the server 11 through the communication network 13 (in S05). In this case, the AR content information may be stored in the storage unit 33 of the terminal device 12.

After the process of S05 or if the AR marker is not recognized in the process of S03 (No in S03), the controller 41 determines whether or not the AR application is terminated (in S06). If the AR application is not terminated (No in S06), the authoring process returns to the process of S02. If the AR application is terminated in accordance with an instruction from the user or the like (Yes in S06), the authoring process is terminated.

### First Embodiment of Display Control Process

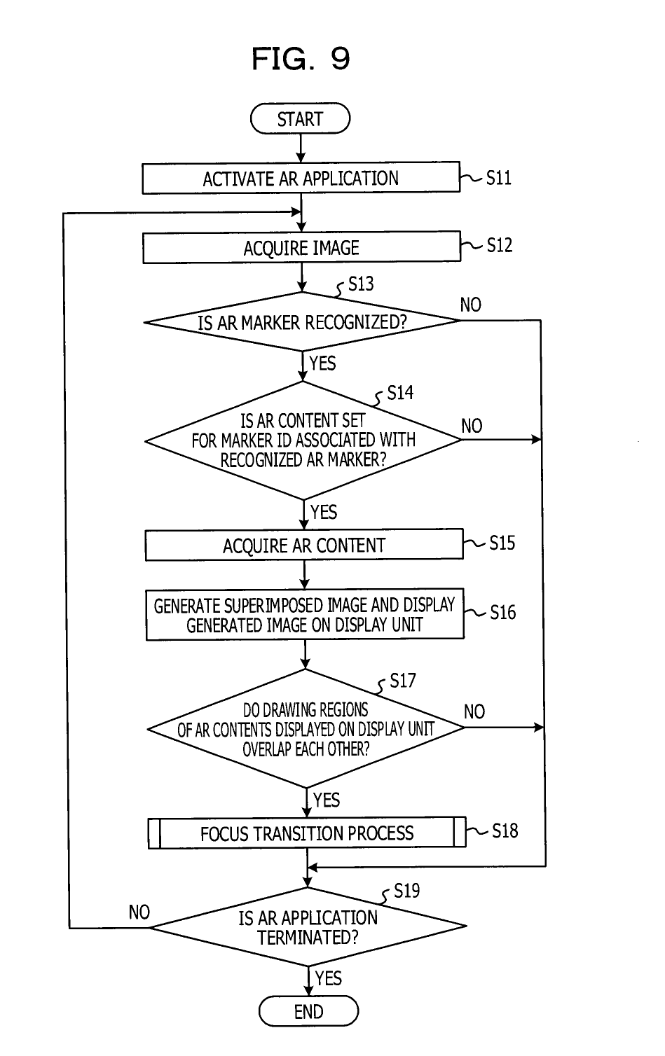

Next, a first embodiment of the display control process according to the embodiment is described with reference to a flowchart. FIG. 9 is the flowchart of the first embodiment of the display control process. In the example illustrated in FIG. 9, the controller 41 of the terminal device 12 activates the AR application for executing the display control on an AR content (in S11). Then, the imager 32 acquires an image (in S12). The acquired image is an input image, but the input image is not limited to the image acquired by the imager 32. An image acquired by an external device may be acquired through the communication network 13.

Next, the recognizer 36 executes the marker recognition on the image acquired in the process of S12 and determines whether the recognizer 36 recognizes an AR marker included in the image acquired in the process of S12 (in S13). If the AR marker is recognized in the process of S13 (Yes in S13), the acquirer 37 determines whether or not an AR content is set for a marker ID associated with the AR marker recognized by the marker recognition (in S14).

In the process of S14, the acquirer 37 may use the marker ID to request the server 11 to acquire the AR content and may determine whether or not the AR content associated with the marker ID is set. Alternatively, the acquirer 37 may reference the storage unit 33 using the marker ID and may determine whether or not the AR content associated with the marker ID is set. In the first embodiment, the acquirer 37 may first provides an inquiry to the server 11 or may first reference the storage unit 33. By providing the inquiry to the server 11, the latest AR content managed by the server 11 for the marker ID may be acquired. In addition, by referencing the storage unit 33, information stored in the storage unit 33 may be superimposed and displayed even in an environment in which the terminal device 12 is not able to communicate with the server 11 (communication is not possible).

If the AR content is set for the marker ID associated with the recognized AR marker in the process of S14 (Yes in S14), the acquirer 37 acquires the AR content (in S15), the image generator 40 generates an superimposed image in which the acquired AR content is superimposed on the image acquired in S02, and the image generator 40 displays the superimposed image on the display unit 34 (in S16).

The image generator 40 determines whether or not drawing regions of AR contents displayed on the display unit 34 overlap each other (in S17). If the drawing regions of the AR contents overlap each other (Yes in S17), the image generator 40 executes the focus transition process (in S18).

Next, after the process of S18, or if the AR marker is not recognized from the acquired image in the process of S13 (No in S13), or if the AR content is not set for the marker ID associated with the recognized AR marker in the process of S14 (No in S14), or if the drawing regions of the AR contents do not overlap each other in the process of S17 (No in S17), the controller 41 determines whether or not the AR application is terminated (in S19). If the AR application is not terminated (No in S19), the controller 41 causes the display control process to return to the process of S12. If the AR application is terminated in accordance with an instruction from the user or the like (Yes in S19), the controller 41 terminates the display control process (first embodiment).

Example of Focus Transition Process of S18

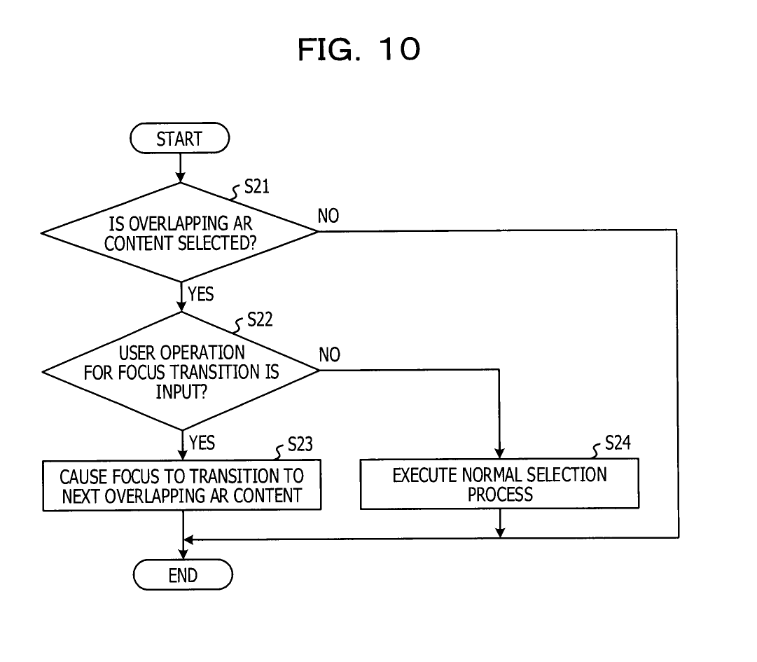

Next, an example of the focus transition process of S18 is described with reference to a flowchart. FIG. 10 is the flowchart of the example of the focus transition process. In the focus transition process, if a certain overlapping AR content (superimposition data) exists behind anther AR content, and the selection of the other AR content is instructed, the certain AR content is selected and the focus is changed to the certain AR content.

In the example illustrated in FIG. 10, the image generator 40 determines whether or not an overlapping AR content is selected (in S21). Whether or not the overlapping AR content is selected may be determined by comparing a position touched on the screen by the user and acquired from the input unit 35 with coordinate values of the displayed AR content.

If the overlapping AR content is selected (Yes in S21), the image generator 40 determines whether or not a user operation (for example, a long tap operation) for the focus transition is input (in S22). The user operation for the focus transition is the operation method stored in the aforementioned operation management table illustrated in FIG. 7D or the like, for example.

If the user operation for the focus transition is input (Yes in S22), the focus (selected state) transitions to a next overlapping AR content (in S23). The next AR content is an AR content arranged immediately under the currently focused AR content. If the user operation for the focus transition is not input (No in S22), a normal selection operation (for example, a single tap operation) is treated to have been input and a normal selection process is executed (in S24). The normal selection process is to display detailed information associated with the AR content, display an image, reproduce a video image, output a sound, or the like, but is not limited to this.

If the overlapping AR content is not selected in the process of S21 (No in S21), a user operation is not performed and the focus transition process is terminated.

### Examples of Screen Display According to First Embodiment

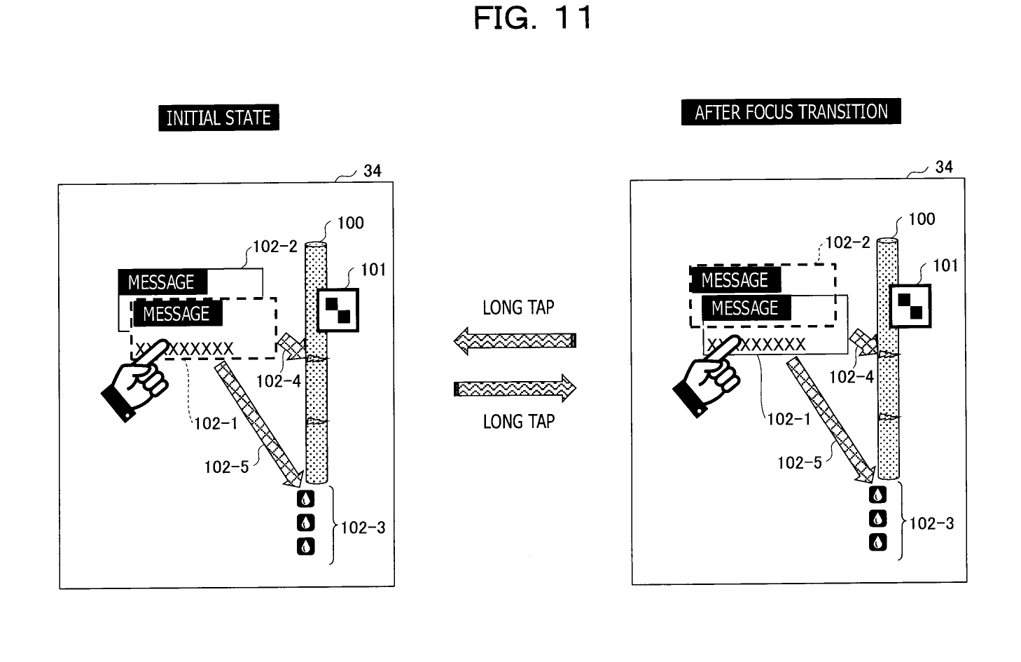

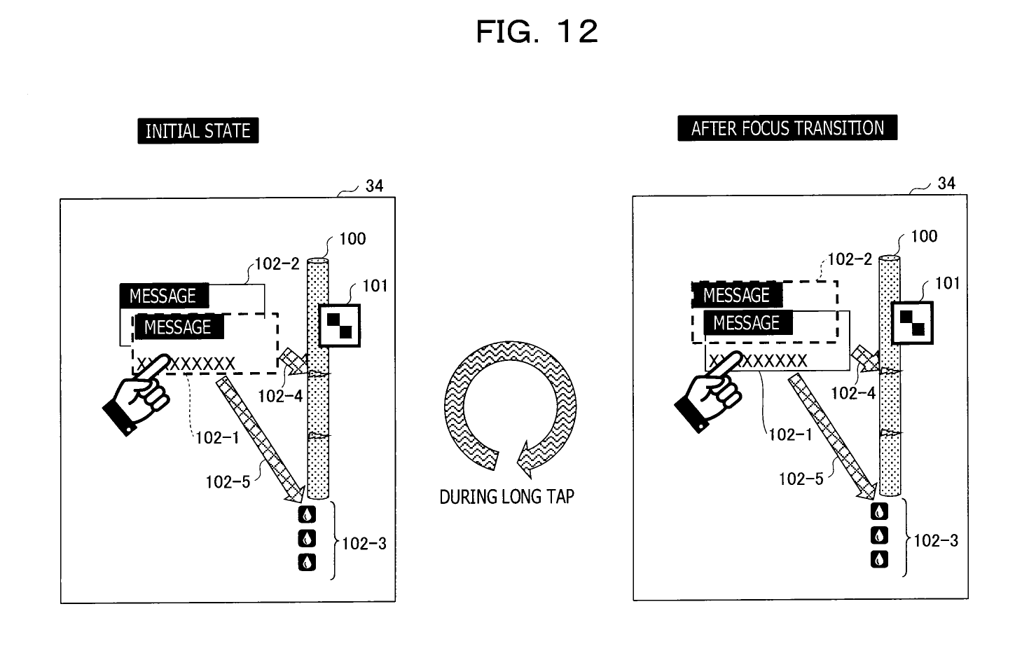

Next, examples of screen display according to the first embodiment are described. FIGS. 11 and 12 are diagrams illustrating the examples of the screen display.

In the examples illustrated in FIGS. 11 and 12, an AR marker 101 is attached to a real object 100 that is a pipe or the like and is included in an acquired image. The AR marker as an example of a reference object may be a two-dimensional code such as a barcode or a QR code (registered trademark) or may be a multidimensional code using colors or the like, but is not limited to this. In addition, for example, a real object such as a wall clock or a desk may be used instead of the AR marker 101 illustrated in FIGS. 11 and 12.

In addition, AR contents 102-1 to 102-5 that are associated with the AR marker 101 are displayed (drawn) as superimposed data in the acquired image on the display unit 34 of the terminal device 12. The AR content 102-4 is a related AR content of the AR content 102-1, while the AR content 102-5 is a related AR content of the AR content 102-2.

FIG. 11 illustrates an example of the screen in an initial state and an example of the screen after the focus transition. In the example illustrated in FIG. 11, the AR content 102-1 and the AR content 102-2 overlap each other in a certain region. In the initial state, the AR content 102-1 drawn on the front side is focused. When the user performs the user operation (for example, a long tap operation) for the focus transition on the AR contents 102-1 and 102-2 on the screen, the focus transitions to the AR content 102-2 drawn on the back side. The position of a point at which the user performs the long tap operation is preferably in an overlapping region represented by the region management table illustrated in FIG. 7F, but is not limited to this. For example, the position of the point at which the user performs the long tap operation may be in a region surrounded by drawing coordinate values corresponding to the AR contents 102-1 and 102-2 and represented by the screen management table illustrated in FIG. 7C.

In the example illustrated in FIG. 11, the focus sequentially transitions between the overlapping AR contents by repeating the long tap operation. Thus, in the example illustrated in FIG. 11, selected states (focused states) of the two AR contents 102-1 and 102-2 are switched by repeatedly performing the long tap operation. When a single tap operation (tap action) or the like is performed on a focused AR content, detailed information (for example, a web page), an image, a video image, a sound, or the like of the focused AR content is displayed, reproduced, output, or the like as the normal selection operation.

In addition, in the example illustrated in FIG. 11, the focus sequentially transitions between the AR contents by repeating the long tap operation, but is not limited to this. For example, as illustrated in the example of FIG. 12, the focus may sequentially transition at predetermined time intervals during the long tap operation.

In the example illustrated in FIG. 12, during the long tap operation (for example, during a time period from the time when a finger of the user taps on the screen of the display unit 34 to the time when the user releases the finger from the screen), the focus sequentially transitions between the overlapping AR contents in the aforementioned manner. Thus, in the example illustrated in FIG. 12, the selected states (focused states) of the two AR contents 102-1 and 102-2 are alternately switched during the long tap operation.

The predetermined time intervals may be fixed time intervals (of, for example, 1 to 3 seconds or the like) or may be set by the user. In addition, the AR contents may be focused for time periods based on the types of the AR contents. Thus, if the AR contents include characteristic information or the like, the AR contents may be focused for time periods in which details of the AR contents are recognized. If the AR contents are signs, marks, or the like and are quickly recognized, the predetermined time intervals may be set to short focus time intervals.

In addition, the image generator 40 may cause the related AR content 102-4 to be focused during the time when the AR content 102-1 is focused. In addition, the image generator 40 may cause the related AR content 102-5 to be focused during the time when the AR content 102-2 is focused. Thus, the multiple related AR contents may be easily recognized on the screen.

The aforementioned user operation performed to cause the focus to transition is not limited to the long tap operation. In the first embodiment, the focus may transition based on input information (for example, an instruction command) set in advance instead of the user operation.

### Second Embodiment of Display Control Process

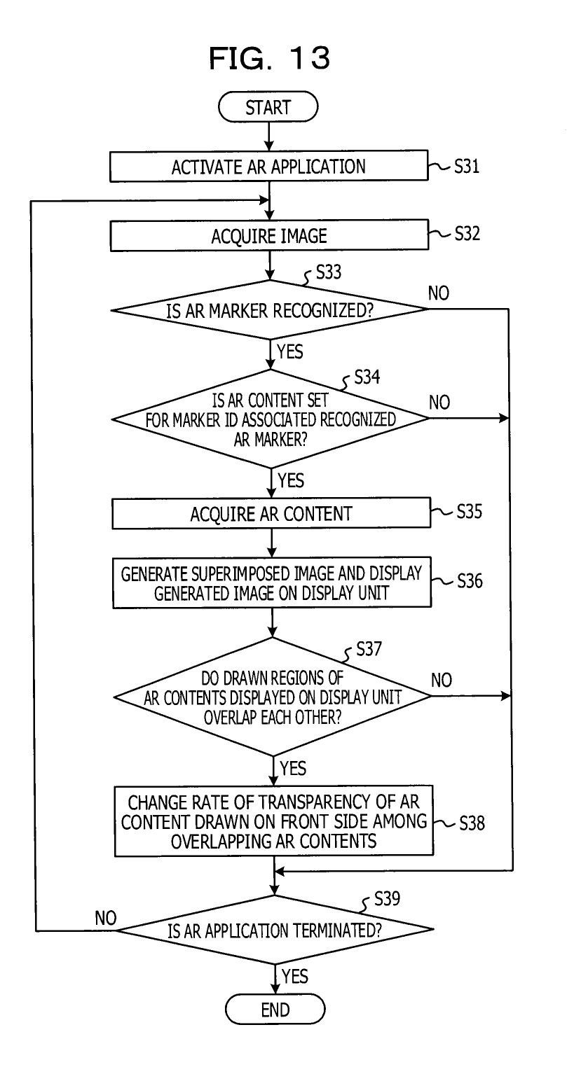

Next, a second embodiment of the display control process according to the embodiment is described with reference to a flowchart. FIG. 13 is the flowchart of the second embodiment of the display control process. In the second embodiment, when a certain AR content (superimposition data) exists behind another AR content, the terminal device 12 executes the display control so as to control the rate of transparency of the other AR content. For example, in the second embodiment, since the terminal device 12 changes the rate of transparency of the other AR content so as to generate a semi-transparent or transparent image, the user easily recognizes that the certain AR content exists on the back side.

In the example illustrated in FIG. 13, processes of S31 to S37 are the same as the aforementioned processes of S11 to S17, and a specific description thereof is omitted. If the drawing regions of the AR contents displayed on the display unit 34 overlap each other in the process of S37 (Yes in S37), the image generator 40 changes the rate of transparency of an overlapping AR content displayed on the front side (in S38).

In a process of S38, if multiple AR contents overlap each other, the image generator 40 executes control so as to reduce the rate of transparency of the AR contents to rate of transparency varying at predetermined intervals in order from an AR content drawn on the front side to an AR content drawn on the back side and display the AR contents. For example, if four AR contents are displayed while overlapping each other, the image generator 40 executes the display control so as to set the rate of transparency of an AR content drawn at the top to a predetermined value (of, for example, 90%), the rate of transparency of an AR content drawn at the second top (or behind the AR content drawn at the top) to 70% (−20%), and the rate of transparency of an AR content drawn at the third top (or behind the AR content drawn at the second top) to 50% (−20%). An AR content that is drawn at the bottom is not made transparent, and thus the rate of transparency of the AR content drawn at the bottom is set to 0%. The rate of transparency may be stored in the storage unit 33 or the like in advance. The rate of transparency may not be changed to the values varying at the predetermined intervals and may be a fixed value or may be reduced to values that are varying at different intervals.

After the process of S38, or if the AR marker is not recognized from the acquired image in the process of S33 (No in S33), or if the AR content is not set for the marker ID associated with the recognized AR marker in the process of S34 (No in S34), or if the drawing regions of the AR contents do not overlap each other in the process of S37 (No in S37), the controller 41 determines whether or not the AR application is terminated (in S39). If the AR application is not terminated (No in S39), the controller 41 causes the display control process to return to the process of S32. If the AR application is terminated in accordance with an instruction from the user or the like (Yes in S39), the controller 41 terminates the display control process (the second embodiment).

### Examples of Display Screen According to Second Embodiment

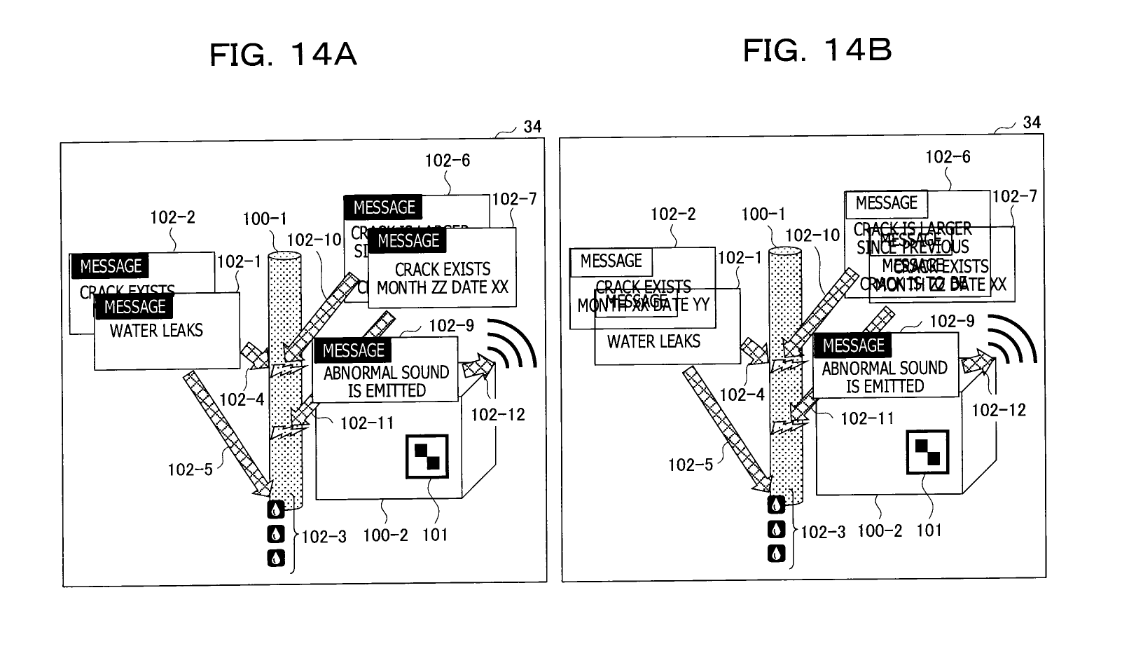

Next, an example of the display screen according to the second embodiment is described with reference to FIGS. 14A and 14B. FIG. 14A illustrates an example of the display screen when transmission display is not executed, while FIG. 14B illustrates the example of the display screen according to the second embodiment.

In the examples illustrated in FIGS. 14A and 14B, the AR marker 101 is attached to a real object 100-2 among real objects 100-1 and 100-2 included in an acquired image displayed on the display unit 34. In addition, AR contents 102-1 to 102-12 are associated with the AR marker 101 and displayed (drawn) as superimposed data on the acquired image displayed on the display unit 34 of the terminal device 12. The AR content 102-4 is a related AR content of the AR content 102-1, while the AR content 102-5 is a related AR content of the AR content 102-2. In addition, the AR content 102-10 is a related AR content of the AR content 102-6, the AR content 102-11 is a related AR content of the AR content 102-7, and the AR content 102-12 is a related AR content of the AR content 102-9.

In the second embodiment, AR contents may overlap each other due to the difference between an imaging position upon the authoring process and an imaging position upon the reference (viewing) of an AR content, a limit on arrangement regions, or the like, as illustrated in FIG. 14A. In such a case, in the second embodiment, the overlapping AR contents are displayed while the rate of transparency of the overlapping AR contents are controlled, as illustrated in FIG. 14B.

In the example illustrated in FIG. 14B, the AR contents 102-1 and 102-2 overlap each other, and thus the AR content 102-1 drawn on the front side is displayed so as to ensure that the rate of transparency of the AR content 102-1 is reduced. In addition, in the example illustrated in FIG. 14B, the AR contents 102-6 and 102-7 overlap each other, and the AR content 102-6 drawn on the front side is displayed so as to ensure that the rate of transparency of the AR content 102-6 is reduced. Since the AR contents 102-9 and 102-11 illustrated in FIG. 14B that overlap each other are a text content and an arrow content, respectively, the meaning of the AR contents 102-9 and 102-11 may be understood without the execution of the rate of transparency control. Thus, in the second embodiment, the image generator 40 may not control the rate of transparency of overlapping AR contents, depending on the types of the AR contents.

In the second embodiment, the same rate of transparency control may be executed on related AR contents of AR contents subjected to the rate of transparency control.

When the AR contents overlap each other as illustrated in FIG. 14A, control may be executed so as to change, at predetermined intervals, the order in which the AR contents are displayed (or so as to change the order so that the AR contents drawn on the back side are displayed at the top).

### Third Embodiment of Display Control Process

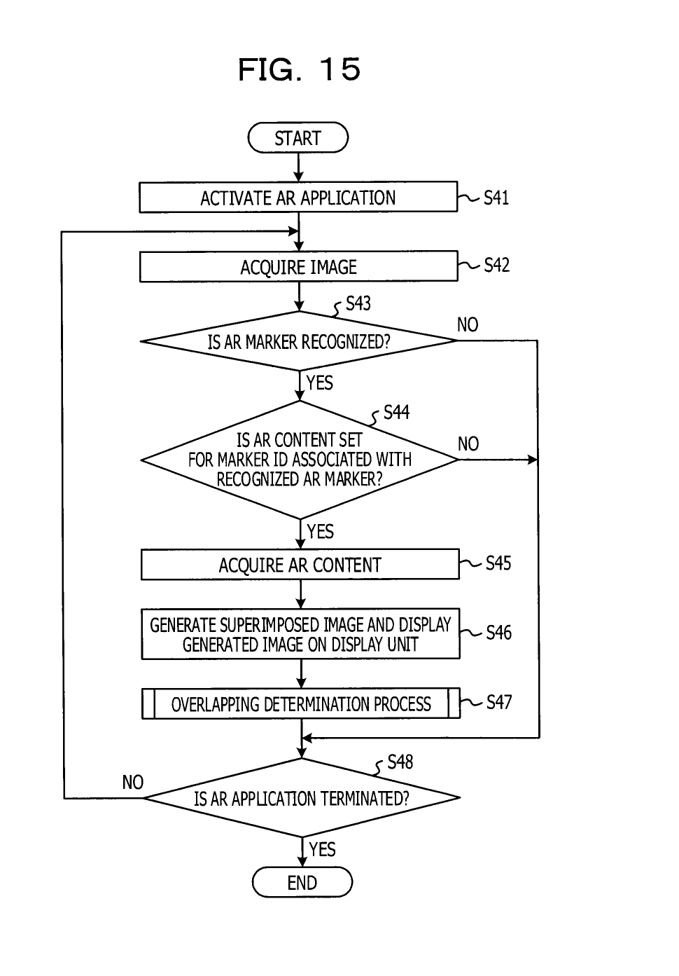

Next, a third embodiment of the display control process according to the embodiment is described with reference to a flowchart. FIG. 15 is the flowchart of the third embodiment of the display control process. In the third embodiment, if AR contents (superimposition data) overlap each other, the terminal device 12 counts the number of the overlapping AR contents and displays, on the screen, an AR content representing the number of the overlapping AR contents. Thus, even if an AR content drawn on the back side is completely hidden by an AR content drawn on the front side, the terminal device 12 may enable the user to recognize that the AR contents overlap each other.

In the example illustrated in FIG. 15, processes of S41 to S46 are the same as the aforementioned processes of S11 to S16, and a description thereof is omitted. After the process of S46, the image generator 40 executes an overlapping determination process according to the third embodiment (in S47).

In the process of S47, the image generator 40 determines whether or not AR contents overlap each other. If the AR contents overlap each other, the image generator 40 counts the number of the overlapping AR contents in the process of S47. In addition, the image generator 40 displays an AR content representing the number of the overlapping AR contents on the screen at a position associated with a region in which the AR contents overlap each other.

After the process of S47, or if the AR marker is not recognized from the acquired image in the process of S43 (No in S43), or if the AR content is not set for the marker ID associated with the recognized AR marker in the process of S44 (No in S44), the controller 41 determines whether or not the AR application is terminated (in S48). If the AR application is not terminated (in S48), the controller 41 causes the display control process to return to the process of S42. If the AR application is terminated in accordance with an instruction from the user or the like (Yes in S48), the controller 41 terminates the display control process (third embodiment).

Example of Overlapping Determination Process of S47

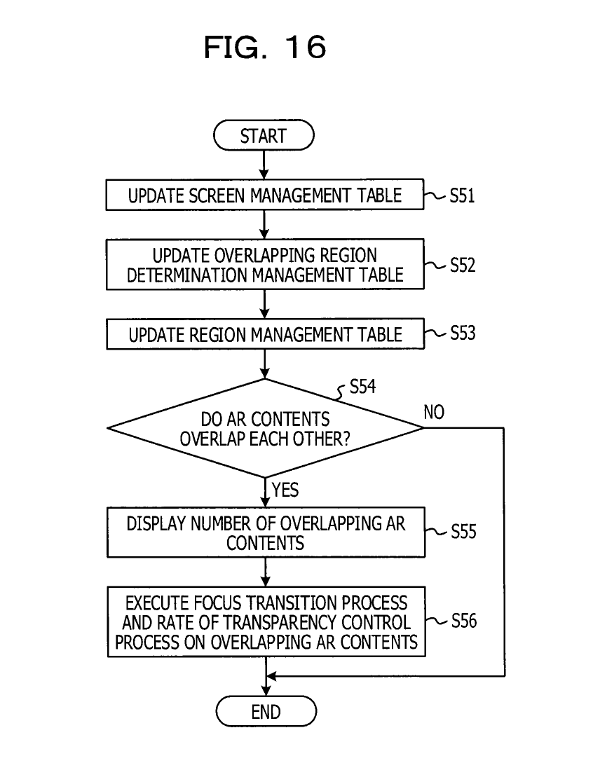

Next, an example of the aforementioned overlapping determination process of S47 according to the third embodiment is described with reference to a flowchart. FIG. 16 is the flowchart of the example of the overlapping determination process. In the example illustrated in FIG. 16, the image generator 40 updates the aforementioned screen management table illustrated in FIG. 7C (in S51), updates the overlapping region determination management table illustrated in FIG. 7E (in S52), and updates the region management table illustrated in FIG. 7F (in S53). In the processes of S51 to S53, the image generator 40 acquires, based on the current acquired image and the position, angle, and the like of the AR marker included in the acquired image, coordinate values of AR contents to be drawn (superimposed), coordinate values of AR contents if the AR contents overlap each other, related AR contents, content IDs of contents within an overlapping region, and the like.

Next, the image generator 40 references the tables updated in the processes of S51 to S53 and determines whether or not AR contents overlap each other (in S54). If the AR contents overlap each other (Yes in S54), the image generator 40 displays, as an AR content, the number of the overlapping AR contents on the display unit 34 (in S55). The number of the overlapping AR contents may be acquired by counting the number of overlapping AR content IDs represented by the overlapping region determination management table illustrated in FIG. 7E or counting the number of overlapping AR content IDs represented by the region management table illustrated in FIG. 7F. In addition, the order in which the AR contents overlap each other may be acquired from the region management table illustrated in FIG. 7F.

Next, the image generator 40 executes the aforementioned focus transition process according to the first embodiment, the rate of transparency control process according to the second embodiment, and the like on the aforementioned overlapping AR contents (in S56).

After the process of S56, or if the AR contents do not overlap each other in the process of S54 (No in S54), the overlapping determination process is terminated.

### Example of Display Screen According to Third Embodiment

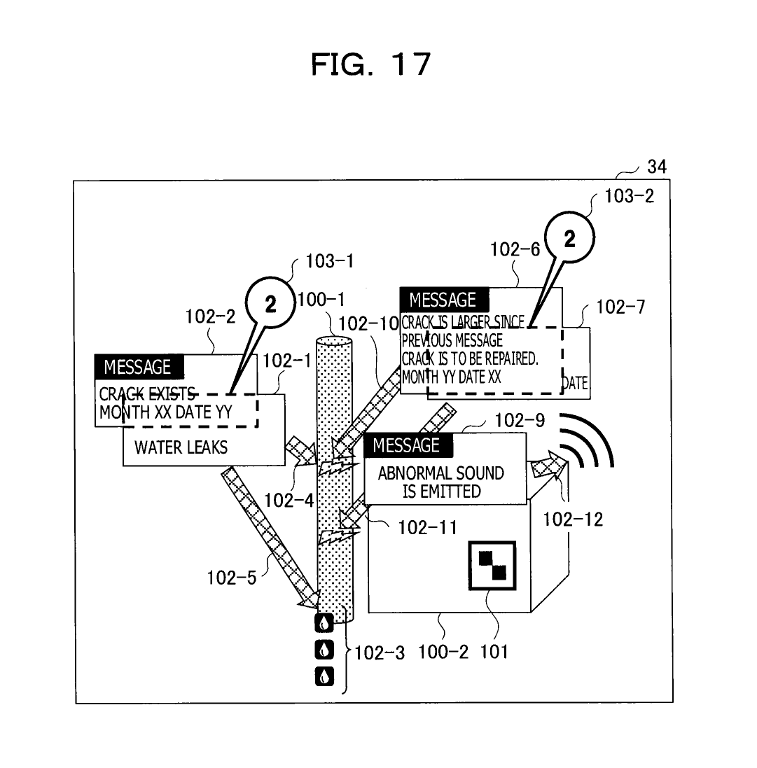

Next, an example of the display screen according to the third embodiment is described with reference to FIG. 17. FIG. 17 is a diagram illustrating the example of the display screen according to the third embodiment. In FIG. 17, AR contents subjected to the rate of transparency control according to the second embodiment are displayed as an example. In the example illustrated in FIG. 17, the real object 100-2, which is among the real objects 100-1 and 100-2 included in the acquired image displayed on the display unit 34, is attached to the AR marker 101 in the same manner as the aforementioned FIGS. 14A and 14B. In addition, the AR contents 102-1 to 102-12 that are associated with the AR marker 101 are displayed (drawn) as superimposed data on the acquired image displayed on the display unit 34 of the terminal device 12.

In the third embodiment, the image generator 40 uses AR contents 103-1 and 103-2 of predetermined icons illustrated in FIG. 17 to display the numbers of the overlapping AR contents that are obtained by the aforementioned overlapping determination process. In addition, the image generator 40 associates the AR contents 103-1 and 103-2 with overlapping regions and displays the AR contents 103-1 and 103-2. Thus, if many AR contents overlap each other and the number of the overlapping AR contents is not recognized or if AR contents overlap each other so that an AR content is completely hidden by an AR content drawn on the front side, the number of the overlapping AR contents may be appropriately recognized.

In the example illustrated in FIG. 17, the third embodiment is combined with the transmission display according to the second embodiment, but may be combined with the aforementioned focus transition process according to the first embodiment. For example, in the third embodiment, the number of overlapping AR contents may be displayed on the acquired image illustrated in FIG. 14A, and the overlapping AR contents may be recognized.

In the example illustrated in FIG. 14A, if the number of overlapping AR contents is displayed as described in the third embodiment, the display control may be executed so as to display, in order, the overlapping AR contents at the top at predetermined time intervals (of, for example, 1 to 3 seconds). If the number of overlapping AR contents is not displayed and the AR contents are displayed in order by toggling, the number of the overlapping AR contents may not be recognized. However, by displaying the number of overlapping AR contents as described in the third embodiment and displaying the AR contents at the top by toggling, the AR contents may be appropriately recognized by the user.

The display control process described in the first to third embodiments is executed by the terminal devices 12, but is not limited to this. An image subjected to the display control process may be generated by the server 11. In this case, the server 11 manages the tables illustrated in FIGS. 7A to 7F, acquires information stored in the tables, an acquired image, and the like, generates images based on the first to third embodiments, and outputs the generated images to the terminal devices 12.

As described above, according to the embodiment, AR contents may be appropriately displayed to the user (for example, a viewer) or the like in a state in which positional relationships between real objects and the AR contents (superimposition data) are maintained. For example, according to the embodiment, even if AR contents (superimposition data) overlap each other, an AR content drawn on the back side may be selected and viewed in a state in which positional relationships between the AR contents and objects existing in a real space defined in advance are maintained.

Although the embodiment is described above, the embodiment may be variously modified and changed within the scope described in claims without being limited to the aforementioned specific embodiment. In addition, parts of or all the aforementioned examples may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A display control method comprising:
acquiring a plurality of contents including a first content and a second content associated with a specific object when the specific object is detected from an image captured by an imaging device;
determining a first display position of the first content based on a position of the specific object in the image;
determining a second display position of the second content based on the position of the specific object;
determining, based on the first display position and the second display position, whether the first content is displayed behind the second content on a display;
controlling the display to display at least the second content; and
controlling, by a processor, the first content to be selected in response to an instruction for the second content displayed on the display when it is determined that the first content is displayed behind the second content on the display.

2. The display control method according to claim 1,
wherein the first content is selected when a display region in which the second content are displayed is designated by a user.

3. The display control method according to claim 2, further comprising:
switching a selected content between the first content and the second content when the display region is repeatedly designated.

4. The display control method according to claim 2, further comprising:
switching a selected content between the first content and the second content at each time intervals while the display region is designated.

5. A display control method comprising:
acquiring a plurality of contents including a first content and a second content associated with a specific object when the specific object is detected from an image captured by an imaging device;
determining a first display position of the first content based on a position of the specific object in the image;
determining a second display position of the second content based on the position of the specific object;
determining, based on the first display position and the second display position, whether the first content is displayed behind the second content on a display; and
controlling the display to display the first content and the second content with a rate of transparency for the second content when the first content is displayed behind the second content.

6. The display control method according to claim 5, further comprising:
determining, when the first content and the second content are displayed behind a third content from among the plurality of contents, the rate of transparency of the second content and another rate of transparency of the third content at certain intervals; and
displaying the third content with the another rate of transparency and the second content with the rate of transparency on the first content, and
wherein the another rate of transparency is higher than the rate of transparency.

7. A system comprising:
circuitry configured to:
acquire a plurality of contents including a first content and a second content associated with a specific object when the specific object is detected from an image captured by an electronic device,
determine a first display position of the first content based on a position of the specific object in the image,
determine a second display position of the second content based on the position of the specific object,
determine, based on the first display position and the second display position, whether the first content is displayed behind the second content on a display,
control the display to display at least the second content, and
control the first content to be selected in response to an instruction for the second content displayed on the display when it is determined that the first content is displayed behind the second content on the display.

8. The system according to claim 7,
wherein the first content is selected when a display region in which the second content are displayed is designated by a user.

9. The system according to claim 8,
wherein the circuitry is configured to switch a selected content between the first content and the second content when the display region is repeatedly designated.

10. The system according to claim 8,
wherein the circuitry is configured to switch a selected content between the first content and the second content at each time intervals while the display region is designated.

11. The system according to claim 7, wherein the first content and the second content include information indicating a task to be performed corresponding to the specific object.

12. The system according to claim 7, wherein the specific object detected from the image is a marker having at least one of a specific shape or pattern.

13. The system according to claim 7, further comprising:
the electronic device, and
wherein the electronic device includes:
an image pickup device configured to capture the image; and
a communication interface configured to send the image to the system via a network.

14. The system according to claim 7, further comprising:
the electronic device, and
wherein the electronic device includes the display configured to display at least the second content on the image.

15. The system according to claim 7, wherein the system is a server.

16. The system according to claim 15, wherein the server includes:
the circuitry; and
a communication interface configured to receive the image from the electronic device via a network and transmit the first content and the second content to the electronic device including the display via the network.
